(19) United States
(12) Patent Application Publication
(10) Pub. No.: US 2018/0061376 A1
(43) Pub. Date: Mar. 1, 2018

(54) ELECTRONIC DEVICE SYSTEM

(71) Applicant: Semiconductor Energy Laboratory Co., Ltd., Atsugi-shi (JP)

(72) Inventors: Takeshi AOKI, Atsugi (JP); Yoshiyuki KUROKAWA, Sagamihara (JP); Yasuhiko TAKEMURA, Isehara (JP)

(21) Appl. No.: 15/682,073

(22) Filed: Aug. 21, 2017

(30) Foreign Application Priority Data
Aug. 24, 2016 (JP) 2016-163236
Aug. 24, 2016 (JP) 2016-163237
Aug. 24, 2016 (JP) 2016-163239

(51) Int. Cl. G09G 5/397; G09G 5/00

(52) U.S. Cl. CPC G09G 5/397; G09G 2340/02; G09G 2350/00; G09G 5/006

(57) ABSTRACT

Providing a new display device and a display method. When image data is sent from a processor to a display unit, the image data is divided into 2 or more parts such as a photographic picture and a non-picture, and corresponding compressed data is generated by performing a suitable compression processing. The size of each of the compressed data is reduced and is thus suitable to be sent to a display unit. Each of the compressed data is decompressed by a display driver; thus becoming decompressed data. Each of the decompressed data is used for display by the display unit. Other than numerical operation, a display unit having a reflective pixel and a self-luminous pixel may be used to combine the decompressed data.

### BACKGROUND OF THE INVENTION

### 1. Field of the Invention

An electronic device system, a driving method thereof, and the like are disclosed.

### 2. Description of the Related Art

The number of pixels in display devices continues to increase, leading to the necessity of swiftly sending a large amount of data to a display driver (see Patent Document 1). Assuming, for example, that the number of pixels in a full-HD liquid crystal display mounted on a certain commercial available smartphone is approximately 2,070,000 (equaling approximately 6,210,000 sub-pixels (only in the case of using three sub-pixels for every pixel)), that the refresh rate of the liquid crystal display is 60 fps, and that 256-level (8-bit) grayscales can be controlled in each sub-pixel, approximately 3 Gbps of digital signals have to be sent to the display driver. If the number of pixels continues to increase even more, it will clearly become an obstacle for sending data to the display driver.

### Patent Document

[Patent Reference 1]

[Patent Document 1] U.S. Published Patent Application No. 2015/0156557

### SUMMARY OF THE INVENTION

A new driving method suitable for display devices with a large number of pixels and an electronic device system based thereon are disclosed.

An electronic device system including a processor, a first circuit (display controller), a second circuit (display driver), and a display unit is disclosed. The processor is configured to generate first image data and second image data. The first circuit is configured to compress the first image data and the second image data under different compression conditions to generate first compressed data and second compressed data. The second circuit is configured to decompress the first compressed data and the second compressed data to generate first decompressed data and second decompressed data. The display unit is configured to use the first decompressed data and the second decompressed data to perform display.

The electronic device system may be configured so that the first compressed data and the second compressed data are in a JPEG format or in a format similar thereto and the first image data is compressed under a reversible compression condition.

Furthermore, an electronic device system including a processor, a first circuit (display controller), a second circuit (display driver), and a display unit is disclosed. The processor is configured to generate first image data and second image data. The first circuit is configured to compress the first image data and the second image data with different compression methods to generate first compressed data and second compressed data. The second circuit is configured to decompress the first compressed data and the second compressed data to generate first decompressed data and second decompressed data. The display unit is configured to use the first decompressed data and the second decompressed data to perform display.

Alternatively, the processor is configured to generate first image data and second image data. The first circuit is configured to compress the first image data and the second image data with a reversible compression method and an irreversible compression method, respectively, to generate first compressed data and second compressed data. The second circuit is configured to decompress the first compressed data and the second compressed data to generate first decompressed data and second decompressed data. The display unit is configured to use the first decompressed data and the second decompressed data to perform display.

The first compressed data may be in a GIF format, a PNG format, or in a format similar thereto, and the second compressed data may be in a JPEG format or in a format similar thereto.

One of the first image data and the second image data may include a pixel specified as black by the processor.

Alternatively, an electronic device system including a processor, a first circuit (display controller), a second circuit (display driver), and a display unit is disclosed. The processor is configured to generate first image data including information specifying transparency or non-transparency and second image data. The first circuit is configured to compress the first image data and the second image data to generate first compressed data and second compressed data. The second circuit is configured to decompress the first compressed data and the second compressed data to generate first decompressed data and second decompressed data. The display unit is configured to use the first decompressed data and the second decompressed data to perform display.

A pixel specified as transparent in the first decompressed data may use data of a pixel corresponding to the second decompressed data to perform display, and a pixel not specified as transparent in the first decompressed data may use data of a pixel corresponding to the first decompressed data to perform display.

The first compressed data may be in a GIF format, a PNG format, or in a format similar thereto, and the second compressed data may be in a JPEG format or in a format similar thereto.

The first circuit may be configured to compress the first image data with a first encoder circuit and the second image data with a second encoder circuit.

The second circuit may be configured to decompress the first compressed data with a first decoder circuit and the second compressed data with a second decoder circuit.

The electronic device system may further include a first data bus and a second data bus, and may be configured so that the first compressed data and the second compressed data are transferred to the second circuit through the first data bus and the second data bus, respectively.

The display unit may include a first display region and a second display region, and may have a structure in which the first display region performs display corresponding to the first decompressed data, the second display region performs display corresponding to the second decompressed data, the first display region overlaps with the second display region, and the first display region is capable of transmitting light emitted from the second display region. The first display region may include a reflective pixel. The second display region may include a self-luminous pixel.

The display unit may include a display region. The display region may be configured to sequentially perform display corresponding to the first decompressed data and display corresponding to the second decompressed data.

The number of pixels of the first image data may be smaller than the number of pixels of the second image data.

An electronic device system suitable for a display with a large number of pixels can be provided. The following description can be referred to for other effects.

### BRIEF DESCRIPTION OF THE DRAWINGS

FIG. 1 illustrates an example of a block diagram of an electronic device system.

FIG. 2 illustrates an example of a block diagram of an electronic device system.

FIG. 3A illustrates an example of an image to be generated and FIGS. 3B and 3C illustrate examples of material images used for generating the image.

FIGS. 4A to 4C illustrate examples of image data to be used.

FIG. 5A illustrates a flow chart of a compression process and FIG. 5B illustrates a flow chart of a decompression process.

FIG. 6 illustrates an example of a block diagram of an electronic device system.

FIG. 7 illustrates an example of a block diagram of an electronic device system.

FIG. 8 illustrates an example of a block diagram of an electronic device system.

FIG. 9A illustrates an example of an image to be generated and FIGS. 9B and 9C illustrate examples of image data used for generating the image.

FIG. 10 illustrates an example of a block diagram of an electronic device system.

FIGS. 11A to 11D are schematic views and a state transition diagram illustrating a structure example of a display device.

FIGS. 12A to 12C are a circuit diagram and timing charts illustrating a structure example of a display device.

FIG. 13 is a perspective view illustrating an example of a display device.

FIG. 14 is a cross-sectional view illustrating an example of a display device.

FIG. 15 is a cross-sectional view illustrating an example of a display device.

FIG. 16 is a cross-sectional view illustrating an example of a display device.

### DETAILED DESCRIPTION OF THE INVENTION

Hereinafter, embodiments will be described with reference to drawings. However, the embodiments can be implemented in many different modes, and it will be readily appreciated by those skilled in the art that modes and details thereof can be changed in various ways without departing from the spirit and scope of the present invention. Thus, the present invention should not be interpreted as being limited to the following description of the embodiments. Furthermore, a technique described in one embodiment can be applied to any of the other embodiments as appropriate.

Note that in structures of the present invention described below, the same portions or portions having similar functions are denoted by the same reference numerals in different drawings, and a description thereof is not repeated. Further, the same hatching pattern is applied to portions having similar functions, and the portions are not especially denoted by reference numerals in some cases.

Note that in the drawings used in this specification, the thicknesses of films, layers, and substrates, the sizes of regions, and the like are exaggerated for simplicity in some cases. Therefore, the sizes of the components are not limited to the sizes in the drawings and relative sizes between the components.

Note that ordinal numbers such as “first” and “second” in this specification and the like are used for convenience and do not denote the order of steps, the stacking order of layers, and the like. Therefore, for example, description can be made even when “first” is replaced with “second” or “third”, as appropriate. In addition, the ordinal numbers in this specification and the like are not necessarily the same as those which specify one embodiment of the present invention.

### EMBODIMENT 1

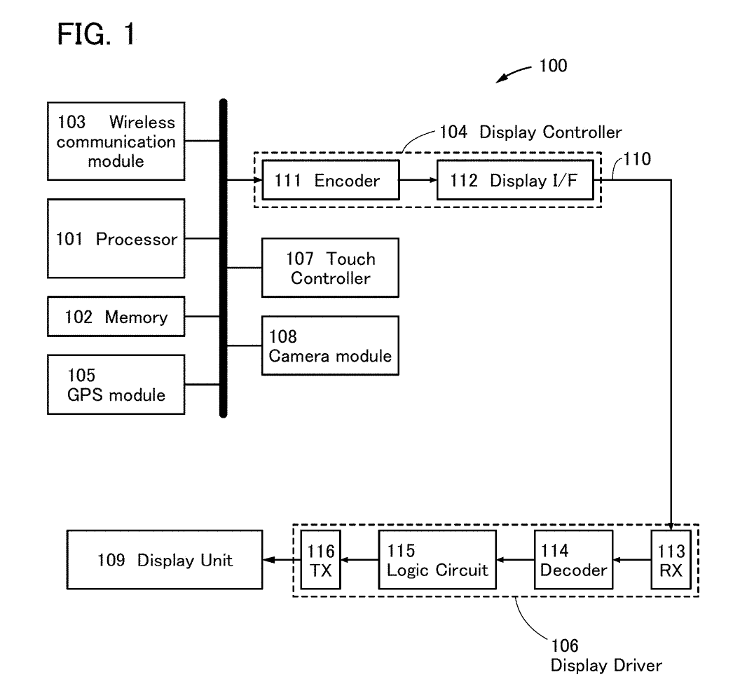

FIG. 1 illustrates a structure of an electronic device system described in this embodiment. An electronic device system 100 includes a processor 101, a memory 102, a wireless communication module 103, a display controller 104, a GPS (global positioning system) module 105, a display driver 106, a touch controller 107, a camera module 108, and a display unit 109. The display controller 104 and the display driver 106 are connected via a data bus 110.

The display controller 104 includes an encoder circuit 111 and a display interface 112. Furthermore, the display driver 106 includes a receiver circuit 113, a decoder circuit 114, a logic circuit 115, and a transceiver circuit 116.

A flow of data displayed on the display unit 109 is briefly described below. The processor 101 processes either data stored in the memory 102 or data obtained from the wireless communication module 103, the GPS module 105, the touch controller 107, the camera module 108, or the like to generate data which is to be displayed on the display unit 109. This data is input to the display controller 104.

Data input to the display controller 104 is compressed by the encoder circuit 111 and output to the display driver 106 from the display interface 112 via the data bus 110. In the electronic device system 100, the data bus 110 has a physical length which is not negligible. Thus, it is necessary to make sure that data does not get lost or damaged. Since data becomes smaller by being compressed by the encoder circuit 111, the data can pass through the data bus 110 at a sufficient low frequency. Consequently, data can be safely sent.

The display driver 106 is provided sufficiently close to the display unit 109. Data input to the display driver 106 is output to the display unit 109 through the receiver circuit 113, the decoder circuit 114, the logic circuit 115, and the transceiver circuit 116. Data is decompressed by the decoder circuit 114, and the decompressed data can be used to perform display.

Here, the encoder circuit 111 can change compressibility depending on the data. For example, as for data that causes image deterioration to be serious in the case where the data is irreversibly and highly compressed (with respect to a spatial frequency) (i.e., when the compression coefficient is reduced) and then decompressed, such as characters and graphics (images in which data between pixels drastically change), the compression coefficient of the data is maintained high, and as for data that causes image deterioration to be less serious even when the data is highly compressed and then decompressed, such as photographs (in which data between pixels continuously change), the compression coefficient of the data is lowered. This can reduce the data size significantly.

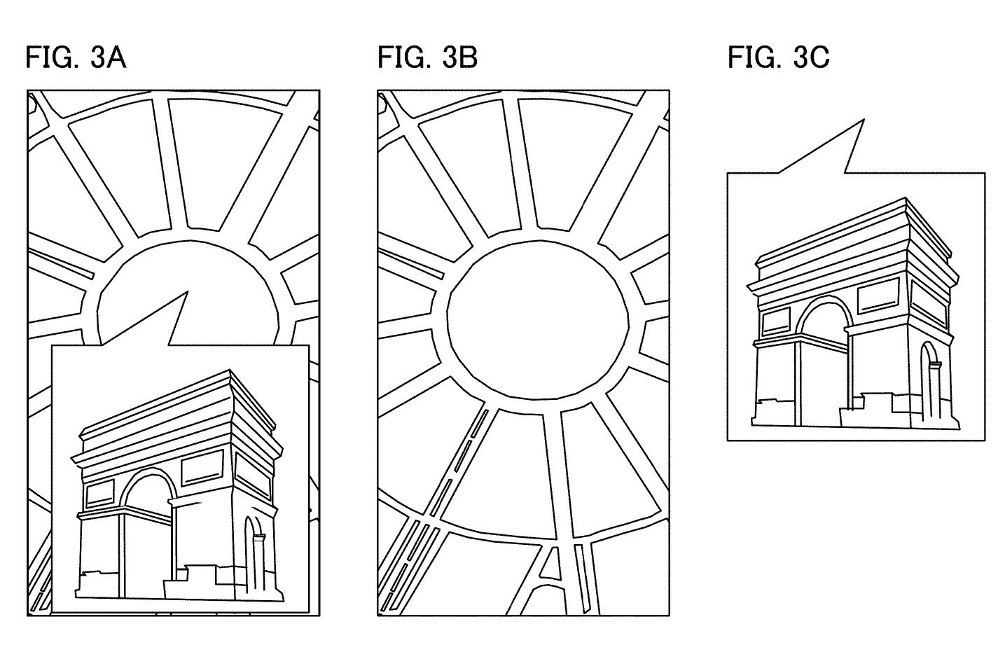

A data processing method based on such an idea will be described. For example, as shown in FIG. 3A, a case is considered where display is performed in such a way that a photograph of the “Triumphal Arch of the Star” overlaps a map of a central part of Paris. Material images used for this display are the map of a central part of Paris (see FIG. 3B) and the photograph of the “Triumphal Arch of the Star” (see FIG. 3C).

In a conventional method, the processor 101 synthesizes these material images and sends the resulting image to the display unit 109 without compression; however, this method processes huge amount of transmission data. Thus, the synthesized image is compressed and then sent in order to reduce the amount of transmission data.

However, when the material images are irreversibly compressed with the same ratio, some parts deteriorate significantly in some cases. When the images are reversibly compressed so as not to cause degradation, it is possible that the data cannot sufficiently be decreased.

For example, the photograph of the “Triumphal Arch of the Star” (see FIG. 3C) can be irreversibly compressed with a relatively low compression coefficient without any problems; however, it is necessary to maintain a high compression coefficient for the map of the central part of Paris.

Thus, data which is equivalent to data divided into the photograph of the “Triumphal Arch of the Star” and the map of the central part of Paris is generated by the processor 101. Note that in order to create objective data, it is easier to process material images with the processor than to divide data into the photograph of the “Triumphal Arch of the Star” and the map of the central part of Paris after the images are synthesized.

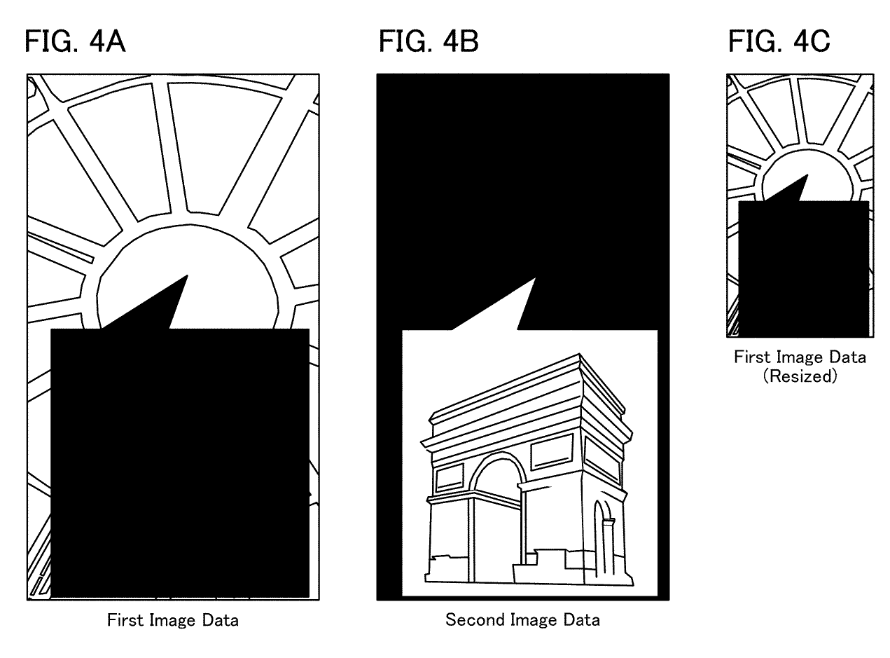

First, the number of pixels for the material images (shown in FIGS. 3B and 3C) is made to be the same. Then, as shown in FIG. 4A, the map of the central part of Paris (see FIG. 3B) is processed into data (first image data) specifying the central portion (the part where the photograph of the “Triumphal Arch of the Star” is to be displayed) as black (a value of 0), for example. Furthermore, as shown in FIG. 4B, the photograph of the “Triumphal Arch of the Star” (see FIG. 3C) is processed into data (second image data) specifying its surrounding area (the part where the map is to be displayed) as black. These processes may be performed by the processor 101.

Here, for example, when the number of pixels in the display unit 109 is 1920×1080, the first image data and the second image data may include pixels corresponding thereto. Alternatively, in order to reduce the amount of data, the number of pixels in the first image data can be made smaller (e.g., 960×540), while maintaining 1920×1080 pixels in the second image data (see FIG. 4C). In general, graphic data such as the first image data differs from the photograph-like second image data in that it does not give an unnatural feeling even when the resolution is reduced. These processes may be performed by the processor 101.

Image data in which the number of pixels has been reduced in such a way is referred to as resized first image data (or resized second image data). Below, unless otherwise specified, first image data (or second image data) includes resized first image data (or resized second image data).

The first image data and the second image data are sent to the encoder circuit 111. The first image data and the second image data are compressed by the encoder circuit 111 using different compression coefficients. For example, in the case of using a JPEG (Joint Photographic Experts Group) format as the compression format, the compression coefficient for the first image data may be 1 and the compression coefficient for the second image data may be 0.5.

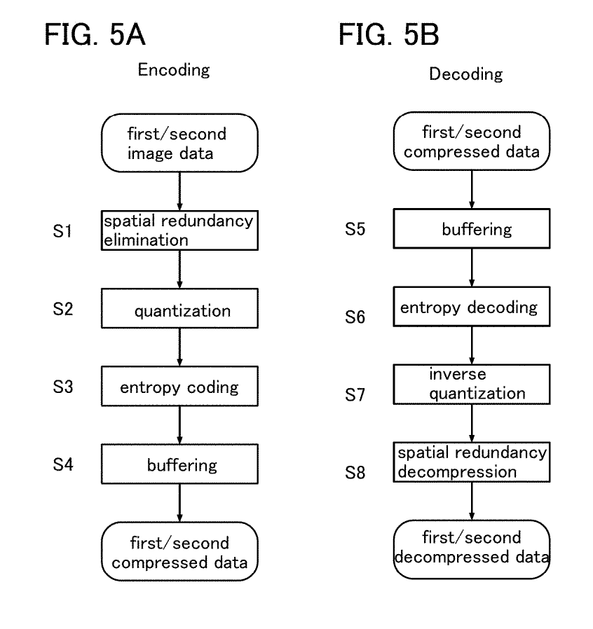

An example of the compression process by the encoder circuit 111 is shown in FIG. 5A. In Step S1, a spatial redundancy elimination is performed on the first image data (or the second image data). Furthermore, after quantization is performed in Step S2 and entropy coding is performed in Step S3, buffering (velocity adjustment) is performed in Step S4. Through those steps, first compressed data (or second compressed data) can be obtained.

The compression may be performed in any order. Here, the first image data is compressed first, and then the second image data is compressed. As a result of the compression by the encoder circuit 111, the first image data and the second image data become first compressed data and second compressed data, respectively.

The first compressed data and the second compressed data are combined by the display interface 112 and sent to the display driver 106. Since the first compressed data and the second compressed data are smaller in size than the first image data and the second image data, the first compressed data and the second compressed data are transmitted at a low frequency and pass through the data bus 110 with a low possibility of loss and damage.

Note that the display interface 112 may perform an encryption or a duplication prevention process on the first compressed data, the second compressed data, or data combining the first compressed data and the second compressed data.

Data which has been sent from the display controller 104 is divided by the receiver circuit 113 of the display driver 106 into first compressed data and second compressed data and then sent to the decoder circuit 114. Furthermore, the receiver circuit 113 performs, if necessary, decryption on encrypted first compressed data, encrypted second compressed data, or data combining the encrypted first compressed data and second compressed data.

The decoder circuit 114 decompresses the first compressed data and the second compressed data in accordance with the compression coefficient to generate first decompressed data and second decompressed data, respectively.

An example of a decompression process by the decoder circuit 114 is shown in FIG. 5B. In Step S5, buffering is performed on the first compressed data (or the second compressed data). Furthermore, after entropy decoding is performed in Step S6 and inverse quantization is performed in Step S7, spatial redundancy decompression is performed in Step S8. Through those steps, first decompressed data (or second decompressed data) can be obtained.

In a JPEG format, data is reversibly compressed when the compression coefficient is 1; however, when the compression coefficient is lower than 1, data is irreversibly compressed. Therefore, it is necessary to pay attention that the second decompressed data is not the same as the second image data before the compression. On the other hand, since the first image data is compressed with a compression coefficient of 1, the first decompressed data is the same as the first image data.

In the above example, the first compressed data and the second compressed data are in a JPEG format; however, they may be in a format similar to a JPEG format. A format similar to a JPEG format is defined as follows: while a component that is to be essential in a JPEG format is omitted and/or a component that is to be unnecessary in a JPEG format is added, an image is separated into blocks, the spatial domain is converted into the frequency domain in each block, and entropy coding with the Huffman code is further performed after reducing the amount of information by quantization.

Note that a compression format other than a JPEG format (or a format similar thereto) can be used as long as the compression format is capable of setting different values to compression coefficients. A format capable of reversible compression is preferable, but the format is not limited thereto.

Furthermore, for example, in the case of using, as described above, resized first image data (in the above example, the number of pixels is 960×540), the number of pixels in the first decompressed data is not the same as that in the second decompressed data; thus, it is necessary to expand the first decompressed data so that the number of pixels corresponds to 1920×1080, for example. Specifically, display of one pixel of the first decompressed data may be performed in 2×2 pixels, so that data is expanded to 1920×1080 pixels. First decompressed data (or second decompressed data) below includes data subjected to such an expansion process.

The first decompressed data and the second decompressed data are sent to the logic circuit 115. Here, the first decompressed data and the second decompressed data are synthesized to generate display data. In this process, numerical processing is performed using the first decompressed data and the second decompressed data, for example. Specifically, addition of the values corresponding to each pixel of the first decompressed data and the second decompressed data is performed.

At this time, a part (a pixel) specified as black in the first image data is also black in the first decompressed data. Furthermore, it is highly probable that the part (the pixel) is also black in the second decompressed data. Since the value of black is 0, in pixels which are black in the first decompressed data, the values obtained by addition of the first decompressed data and the second decompressed data (in other words, display data of this part) are the same as the second decompressed data.

In other words, display of a part specified as black in the first image data is the same as display of the second image data. The same applies to a part specified as black in the second image data. As a result, an image close to the one shown in FIG. 3A can be displayed on the display unit 109 with data which is obtained by combining the first decompressed data and the second decompressed data.

Note that since the compression of the second image data is an irreversible compression, the second decompressed data is not exactly the same as the second image data. In other words, even in a part specified as black in the second image data, a pixel which is not black exists in the second decompressed data.

For example, even in a part specified as black in the second image data, it is highly possible that the second decompressed data is not black (a value of higher than 0) in the vicinity of a border with the photograph of the “Triumphal Arch of the Star”. The display data of this part differs in color, luminance, and the like from the image shown in FIG. 3A due to the addition of the first decompressed data, whereby unclarity may occur in the border.

Note that instead of the addition, only the size of the first decompressed data and the size of the second decompressed data in those pixels may simply be determined, and larger data may be used to perform display of those pixels. Here, for example, white is: 100% red, 100% green, and 100% blue; and black is: 0% red, 0% green, and 0% blue. For example, in the case where the first decompressed data in a certain pixel is black (red, green, and blue are each set to 0%), the second decompressed data is used for display of that pixel.

Furthermore, in the case where the first decompressed data supposed to be black is not black (e.g., red is 10%, green is 20%, and blue is 30%) and the second decompressed data is 30% red, 60% green, and 20% blue, for some reasons, the display of that pixel may be set to 30% red, 60% green, and 30% blue using only the higher value of each of the colors.

### EMBODIMENT 2

In the method shown in Embodiment 1, first image data and second image data are sequentially input to one encoder circuit 111 and then compressed; alternatively, a plurality of encoder circuits and a plurality of decoder circuits may be used.

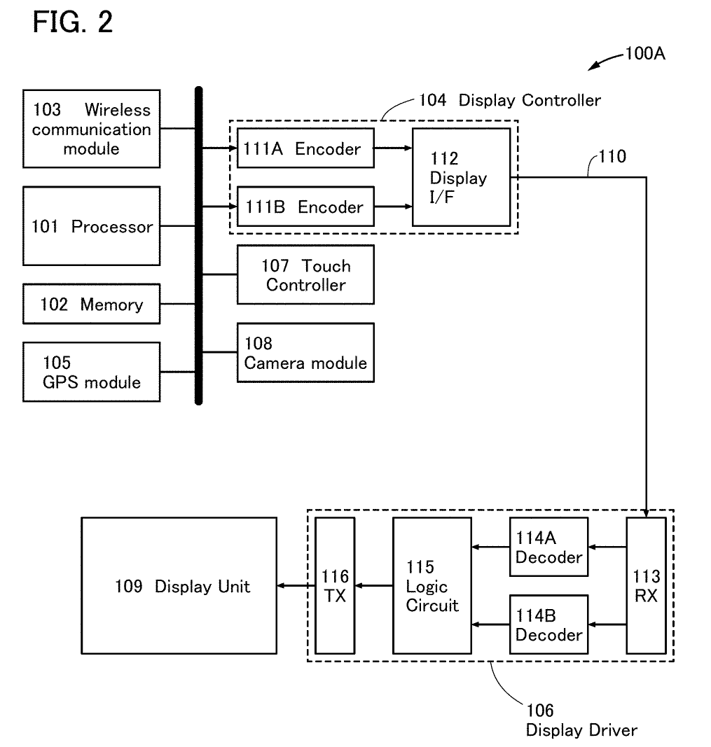

In an electronic device system 100A shown in FIG. 2, an encoder circuit 111A and an encoder circuit 111B compress first image data and second image data, respectively. The compression coefficients may be fixed for each of the encoder circuit 111A and the encoder circuit 111B. For example, the compression coefficient of the encoder circuit 111A may be 1, and the compression coefficient of the encoder circuit 111B may be 0.5.

Furthermore, the electronic device system 100A includes a decoder circuit 114A decompressing the first compressed data and a decoder circuit 114B decompressing the second compressed data. The decoder circuit 114A and the decoder circuit 114B perform the decompression in accordance with the compression coefficients of the encoder circuit 111A and the encoder circuit 111B.

The first decompressed data and the second decompressed data, which have been decompressed by the decoder circuit 114A and the decoder circuit 114B, are added with the logic circuit 115 in a manner similar to the one performed in Embodiment 1, so that data to be displayed on the display unit 109 is obtained.

### EMBODIMENT 3

In Embodiment 2, the first image data and the second image data are compressed in a JPEG format with different compression coefficients; however, different compression formats may be used. For example, the first image data may be compressed into a PNG (Portable Network Graphics) format (or into a format similar thereto) and the second image data may be compressed into a JPEG format (or into a format similar thereto). Note that as the first image data and the second image data, data similar to that of Embodiment 2 can be used, and as shown in FIG. 4B or FIG. 4C, a part specified as black exists.

In that case, the encoder circuit 111A generates first compressed data in a PNG format (or in a format similar thereto) from the first image data, and the encoder circuit 111B generates second compressed data in a JPEG format (or in a format similar thereto) from the second image data.

Furthermore, the decoder circuit 114A generates first decompressed data by decompressing the first compressed data in a PNG format (or in a format similar thereto), and the decoder circuit 114B generates second decompressed data by decompressing second compressed data in a JPEG format (or in a format similar thereto).

Alternatively, the first image data may be compressed into a GIF (Graphics Interchange Format) format (or into a format similar thereto), and the second image data may be compressed into a JPEG format (or into a format similar thereto) or into a PNG format (or into a format similar thereto).

For example, in the case of compressing the first image data into a GIF format and the second image data into a PNG format, since both the GIF format and the PNG format are reversible compression formats, data similar to that before the compression can be obtained after decompression. That is, since a region specified as black in the first image data and the second image data certainly becomes black after decompression, an unclear border ceases to exist.

Since a GIF format has a limitation on the number of colors which can be used, it is not intended to be used for a photographic image, for example; however, the GIF format can be used without any problem for the compression of image data with a small color variation like the first image data. Additionally, the amount of data can be generally made smaller than in a PNG format.

Here, a format similar to a GIF format is defined as follows: while a component that is to be essential in a GIF format is omitted or a component that is to be unnecessary in a GIF format is added, as a compression technology, the Lempel-Ziv algorithm, that is a lexical compression, or an improved version thereof, that is the LZW algorithm is used.

For example, an image file in a normal GIF format has a header of a specific string for identifying the file type; however, the kind of data which is sent via the data bus 110 in the electronic device system 100A is limited; thus, a header may be different from that in an image file in a normal GIF format. When the string used for the header is short, the data becomes smaller.

Furthermore, an image file in a normal GIF format can display 256 colors; however, 255 colors or less and 257 or more may be displayed. In general, by reducing the number of colors which can be displayed, data becomes smaller.

In a manner similar to the above, a format similar to a PNG format is defined as follows: a compression format using as a compression algorithm Deflate (a reversible compression algorithm in which LZ77 and Huffman coding are combined) or a similar algorithm.

Formats used for compression of the first image data and the second image data are not limited to the above, and various formats can be used.

### EMBODIMENT 4

In the methods described in Embodiments 1 to 3, a numerical operation such as an addition is performed on the first decompressed data and the second decompressed data by the logic circuit 115 for each pixel and the resulting values are displayed on the pixels; alternatively, display may be performed by a display unit in which a first display region displaying the first decompressed data and a second display region displaying the second decompressed data are stacked.

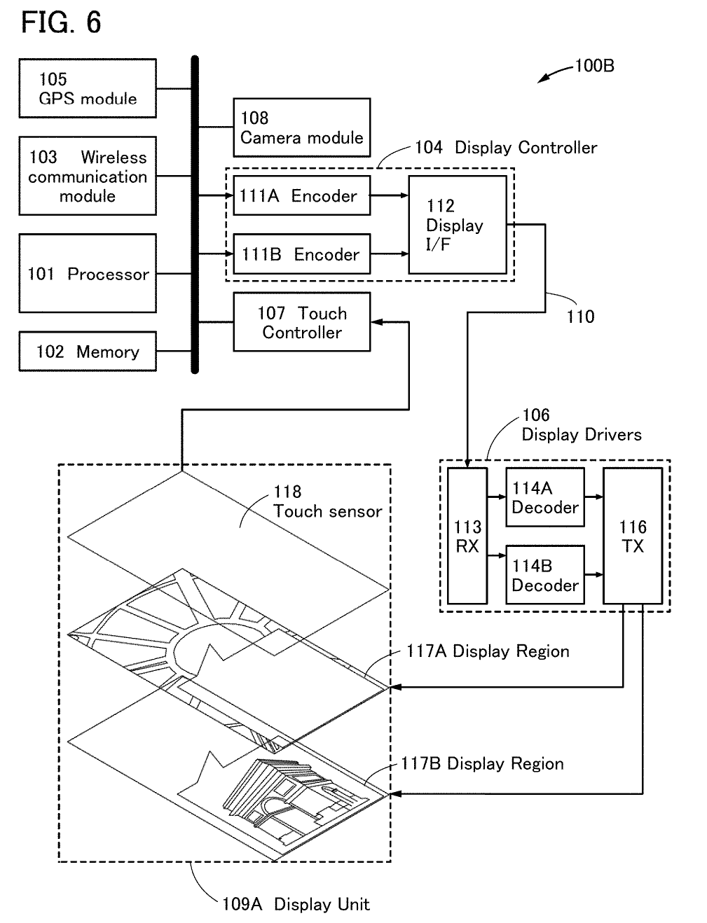

An electronic device system 100B shown in FIG. 6 includes the processor 101, the memory 102, the wireless communication module 103, the display controller 104, the GPS module 105, the display driver 106, the touch controller 107, the camera module 108, and a display unit 109A.

The display controller 104 is the same as the one described in Embodiment 1. In the display driver 106, numerical operation using the first decompressed data and the second decompressed data is unnecessary; thus, a circuit for that purpose is also unnecessary. An effect similar to the numerical operation can physically be achieved in the display unit 109A.

The display unit 109A includes a display region 117A, a display region 117B, and a touch sensor 118, which are stacked in the following order: touch sensor 118, display region 117A, and display region 117B. The display region 117A can transmit display of the display region 117B. A user views the display from the side of the touch sensor 118.

One pixel of the display region 117A may correspond to one or a plurality of pixels of the display region 117B.

For example, the display region 117A has non-reflective pixels arranged in a matrix, and the display region 117B has reflective pixels arranged in a matrix. Alternatively, both the display region 117A and the display region 117B have non-reflective pixels arranged in a matrix. Further alternatively, both the display region 117A and the display region 117B have reflective pixels arranged in a matrix.

As the reflective pixel, a reflective liquid crystal pixel or a reflective MEMS (Micro Electro Mechanical Systems) pixel can be given. As the non-reflective pixel, a transmissive liquid crystal pixel or a self-luminous pixel using, for example, an organic EL element, an inorganic EL element, or a nitride semiconductor light-emitting diode can be given.

In either case, it is necessary that the display region 117A needs to have a structure capable of transmitting the display of the display region 117B. For example, the display region 117A can have a structure in which an opening corresponding to each pixel of the display region 117B is included so as to transmit light emitted from the display region 117B.

In the display unit 109A with such a structure, first decompressed data and second decompressed data are displayed in the display region 117A and the display region 117B, respectively. The first decompressed data and the second decompressed data are similar to the data shown in FIGS. 4A and 4B. A pixel specified as black in one data displays only the luminance and color specified by the other data, and as a result, an image equaling FIG. 3A can be displayed. In other words, this process is similar to the one described in Embodiments 1 to 3 in which the other pixel data is added to the data with a value of 0 of a pixel specified as black in the one data.

FIG. 6 shows a structure that includes the encoder circuit 111A and the encoder circuit 111B, which are used for the compression of the first image data and the second image data, and the decoder circuit 114A and the decoder circuit 114B, which are used for the decompression of the first compressed data and the second compressed data; alternatively, as shown in Embodiment 1, the first image data and the second image data may be compressed by only one encoder circuit 111, and the first compressed data and the second compressed data may be decompressed by only one decoder circuit 114.

### EMBODIMENT 5

In the methods described in Embodiments 1 to 3, a method is described in which a numerical operation is performed for each pixel using the first decompressed data and the second decompressed data and the resulting values are displayed by the pixels; the same effect can be obtained by sequentially displaying the first decompressed data and the second decompressed data on one panel.

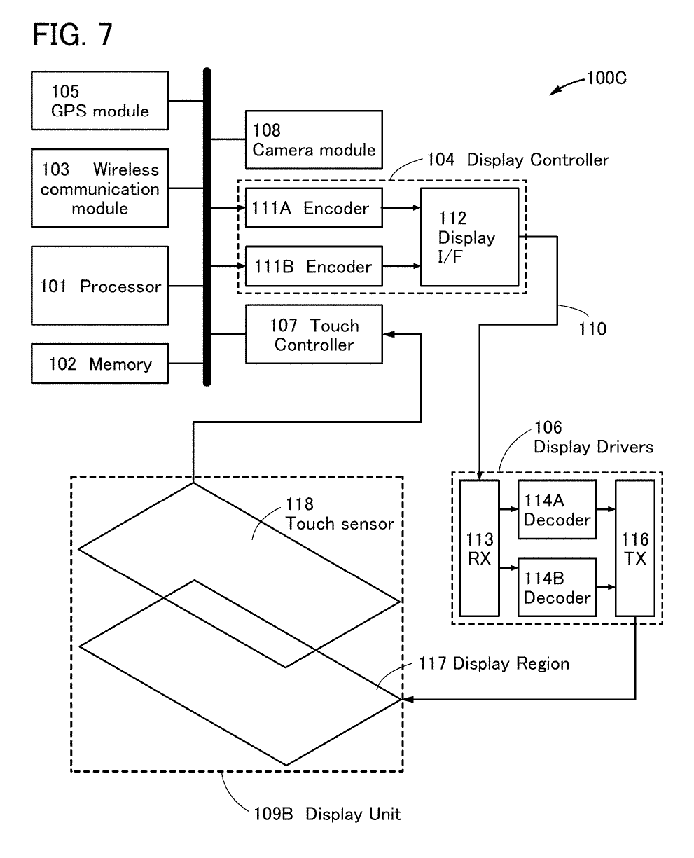

An electronic device system 100C shown in FIG. 7 includes the processor 101, the memory 102, the wireless communication module 103, the display controller 104, the GPS module 105, the display driver 106, the touch controller 107, the camera module 108, and a display unit 109B.

The display controller 104 is the same as the one described in Embodiment 1. In the display driver 106, numerical operation using the first decompressed data and the second decompressed data is unnecessary; thus, a circuit for that purpose is also unnecessary. The display driver 106 (or the transceiver circuit 116) sequentially transfers the first decompressed data and the second decompressed data to the display unit 109B.

The display unit 109B includes a display region 117 and the touch sensor 118. The display region 117 includes reflective pixels arranged in a matrix or non-reflective pixels arranged in a matrix. In the display region 117, the first decompressed data and the second decompressed data are sequentially displayed. That is, one frame displayed in the display region consists of a sub frame displaying the first decompressed data and a sub frame displaying the second decompressed data. As a result, a user perceives the first decompressed data and the second decompressed data that overlap and can thus see an image similar to that shown in FIG. 3A.

FIG. 7 shows a structure that includes the encoder circuit 111A and the encoder circuit 111B, which are used for the compression of the first image data and the second image data, and the decoder circuit 114A and the decoder circuit 114B, which are used for the decompression of the first compressed data and the second compressed data; alternatively, as shown in Embodiment 1, the first image data and the second image data may be compressed by only one encoder circuit 111, and the first compressed data and the second compressed data may be decompressed by only one decoder circuit 114.

In that case, since the first decompressed data and the second decompressed data are sequentially output from the decoder circuit, they only need to be transferred to the display unit 109B by the transceiver circuit 116 at an appropriate timing.

### EMBODIMENT 6

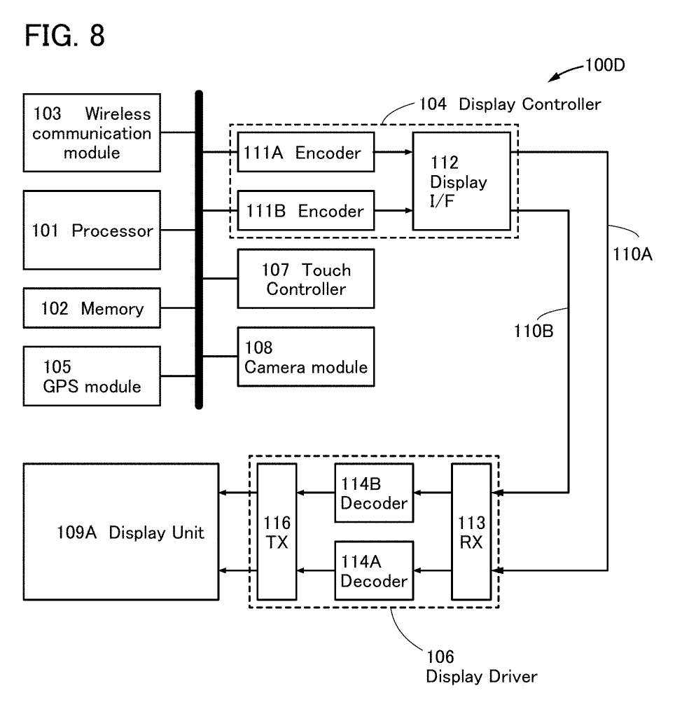

An electronic device system 100D shown in FIG. 8 includes the processor 101, the memory 102, the wireless communication module 103, the display controller 104, the GPS module 105, the display driver 106, the touch controller 107, the camera module 108, and the display unit 109A. The display controller 104 and the display driver 106 are connected via a data bus 110A and a data bus 110B.

The electronic device system 100D is different from the electronic device system 100A shown in FIG. 2 in that the first compressed data is sent via the data bus 110A and the second compressed data is sent via the data bus 110B. Thus, the display interface 112 only needs to perform, if necessary, an encryption or a duplication prevention process on first compressed data and second compressed data output from the encoder circuit 111A and the encoder circuit 111B, and output the resulting data at an appropriate timing which simplifies the configuration. Additionally, the first compressed data and the second compressed data can be transferred faster.

Furthermore, the receiver circuit 113 in the display driver 106 receives first compressed data and second compressed data and sends the first compressed data and the second compressed data to the decoder circuits 114A and 114B, respectively. The receiver circuit 113 only needs to perform, if necessary, decryption on the received first compressed data and the received second compressed data, and output the resulting data at an appropriate timing which simplifies the configuration. Furthermore, first compressed data and second compressed data can be transferred faster.

The first compressed data and the second compressed data are decompressed by the decoder circuit 114A and the decoder circuit 114B, respectively, and first decompressed data and second decompressed data are output to the transceiver circuit 116. The first decompressed data and the second decompressed data are sent to the display unit 109A via the transceiver circuit 116.

The display unit 109A is, for example, the same as the one shown in FIG. 6.

Instead of the display unit 109A, the display unit 109B illustrated in FIG. 7 or other similar structures may be used.

Furthermore, as described in Embodiments 1 to 3, in the case of performing an operation using the first decompressed data and the second decompressed data, an operation circuit for that purpose may be provided, for example.

### EMBODIMENT 7

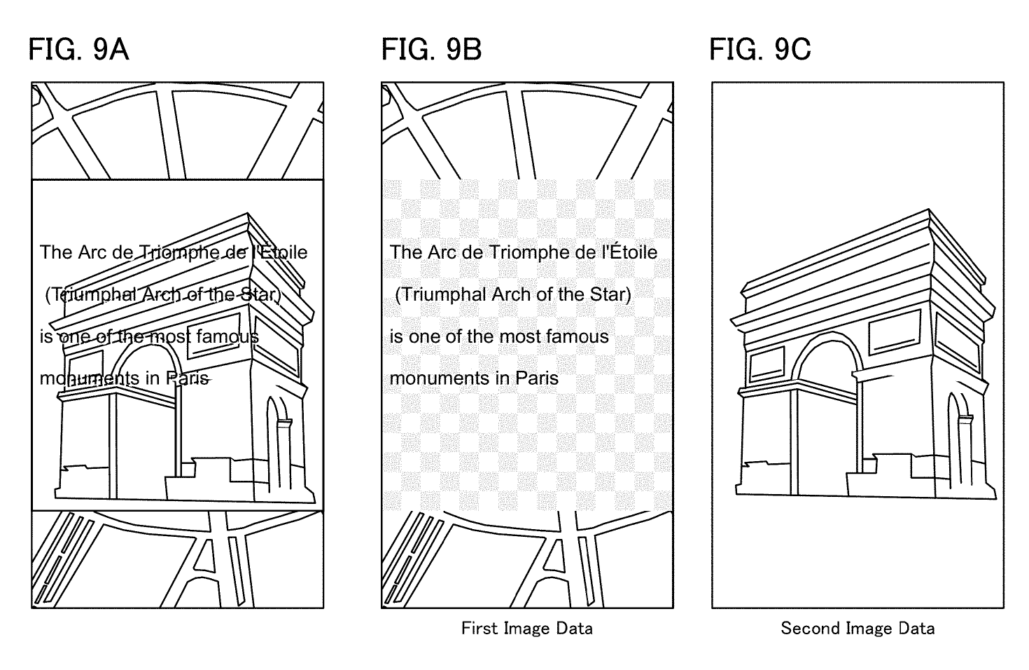

This embodiment shows an example in which the photograph of the “Triumphal Arch of the Star” overlaps the map of the central part of Paris and a description of the “Triumphal Arch” is further displayed over that photograph as shown in FIG. 9A.

In the method employed in Embodiment 1, image data to be displayed is divided into first image data and second image data, and only one of the first image data and the second image data is displayed in each pixel; thus, the data not to be displayed is specified as black (value 0) (see FIGS. 4A and 4B). For example, the first image data is graphic-like data and the second image data is a photo.

In the case where the first image data (or part thereof) are characters overlapping the photo, part (pixels) of the second image data relating to the display of the photograph, in which the characters are displayed, needs to be specified as black. In this case, the second image data practically includes information about the characters and thus the amount of data does not decrease sufficiently. Furthermore, in the case of irreversibly compressing the second image data into a JPEG format (or into a format similar thereto), reproducibility of the second decompressed data decreases (i.e., the difference between the second image data and the second decompressed data increases).

In this embodiment, image data to be displayed is divided into first image data and second image data, and then in order to display only one of the first image data and the second image data in each pixel, the data not to be displayed is specified as transparent. Information regarding the color or luminance does not have to be given to the pixels that do not perform display.

Transparency is different from black. For example, in a 256-color display (8-bit color), normal black is defined as (R, G, B)=(0/2³, 0/2³, 0/2²) and data of a black pixel becomes 8-bit data of “00000000”; in contrast, when transparency is specified, data becomes 9-bit data of “100000000” (in case of adding the information “1”, that is information on transparency, to the head of the data column). In the case where the black pixel is not transparent, data becomes 9-bit data of “000000000” (in case of adding the information “0”, that is information on non-transparency, to the head of the data column).

The first image data and/or the second image data may be specified as transparent. For example, when the first image data is compressed into a GIF format (or into a format similar thereto) or into a PNG format (or into a format similar thereto) and the second image data is compressed into a JPEG format (or into a format similar thereto) to obtain first compressed data and second compressed data, respectively, only the first image data may be specified as transparent. A GIF format or a PNG format supports a transparency function. The second image data in pixels that display only the first image data and do not display the second image data is set to black (value 0) or to a given color. This processing may be performed by the processor 101.

Note that data about the transparency of pixels may be generated separately from data about the color of pixels. That is, as first image data, data about the color, luminance, and the like of a pixel (first image data A) and data on the transparency or non-transparency of a pixel (first image data B) are generated. Accordingly, for example, the first image data A is compressed into a JPEG format and then sent to the display driver 106. Furthermore, the first image data B is compressed into another format or not compressed and then sent to the display driver 106.

Those data is processed by the logic circuit 115 after the decompression. At that time, display of pixels specified by the first image data B as transparent is determined by a method described below. This method can also be employed for a JPEG format not supporting a transparency function, and is thus preferable.

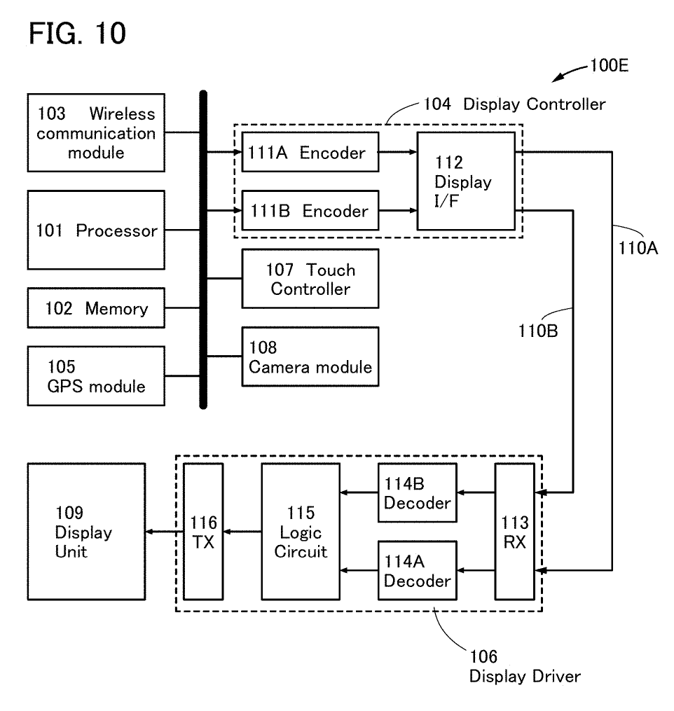

Here, the case of using an electronic device system 100E shown in FIG. 10 will be described. The electronic device system 100E includes the processor 101, the memory 102, the wireless communication module 103, the display controller 104, the GPS module 105, the display driver 106, the touch controller 107, the camera module 108, and the display unit 109. The display controller 104 and the display driver 106 are connected via the data bus 110A and the data bus 110B.

The display driver 106 includes the receiver circuit 113, the decoder circuit 114A, the decoder circuit 114B, the logic circuit 115, and the transceiver circuit 116. The logic circuit 115 performs an operation shown below or stores an operation result. For other components, the electronic device system 100D shown in FIG. 8 can be referred to.

The first image data and the second image data are compressed by the encoder circuit 111A and the encoder circuit 111B, respectively, to generate first compressed data and second compressed data. The first compressed data and the second compressed data are transferred to the display driver 106 via the data bus 110A and the data bus 110B and then decompressed by the decoder circuit 114A and the decoder circuit 114B to become first decompressed data and second decompressed data, respectively.

The first decompressed data and the second decompressed data are synthesized by the logic circuit 115. During the synthesis, it is determined whether each of the pixels is specified as transparent or not. For example, in the case where certain pixels are specified as transparent by the first decompressed data, only the second decompressed data is used for the display of those pixels.

In the case where pixels are not specified as transparent by the first decompressed data, the following two methods are employed: in one method (method A), the sum of the first decompressed data and the second decompressed data is used as in Embodiment 1; in another method (method B), only the first decompressed data is used.

In the case of using the method A, when the second decompressed data is black (value 0), the sum equals the value of the first decompressed data. In the above-described example, in the case where non-display pixels in the second image data are specified as black, the sum of the first decompressed data and the second decompressed data becomes ideally the first decompressed data.

However, even when the second image data of certain pixels is black (the first image data is a specific value), in the case where the second decompressed data becomes a color other than black (a value other than 0) in the compression and decompression processes, for some reasons, display of those pixels becomes the sum of the first decompressed data with a specific value (equaling the first image data) and the second decompressed data with a value other than 0; thus, it differs from the original.

Furthermore, in the case where non-display pixels in the second image data are specified as a specific color other than black (a value higher than 0), using the method A is not appropriate.

In contrast, even when the second decompressed data is a color other than black, the data is not used for the display in those pixels in the method B; thus, the display does not differ from an original one.

The first decompressed data and the second decompressed data are synthesized by the logic circuit 115, sent to the display unit 109 through the transceiver circuit 116, and then used for the display.

Specific examples of the first image data and the second image data are shown in FIGS. 9B and 9C, respectively. Here, first decompressed data and second decompressed data are synthesized using the above-described method B.

Here, first image data includes the map of the central part of Paris and a description about the “Triumphal Arch of the Star”. In the first image data, the part where the photograph of the “Triumphal Arch of the Star” is to be displayed and characters for the description of the “Triumphal Arch of the Star” are not displayed is specified as transparent so as to look like a checkered pattern of grey and white in the figure (see FIG. 9B).

On the other hand, in the second image data, the photograph of the “Triumphal Arch of the Star” can be used after correcting the size (see FIG. 9C). As described-above, in the method B, even when part (pixels) of the second image data is specified as any color (or even in the case where another photographic image exists there), in the case where this part (pixels) is not specified in the first image data as transparent, the part does not need to be specified as black, as shown in Embodiment 1, since only the first decompressed data (equaling the first image data) is used.

Note that in case of using the method A, part (pixels) of the second image data corresponding to the part (the pixels) displaying the first image data, has to be specified as black.

The first image data and the second image data shown in FIGS. 9B and 9C are each compressed, for example, into a GIF format and a JPEG format (compression coefficient is 0.5) by the encoder circuit 111A and the encoder circuit 111B to become first compressed data and second compressed data. These data are transferred to the display driver 106, and then decompressed in the decoder circuit 114A and the decoder circuit 114B to be first decompressed data and second decompressed data, respectively.

Here, when the first image data is compressed into a GIF format (or into a format similar thereto) or into a PNG format (or into a format similar thereto), the first decompressed data can be considered to be the same as the first image data. On the other hand, when the second image data is compressed into a JPEG format (or into a format similar thereto), the second decompressed data is not entirely the same as the second image data.

The first decompressed data and the second decompressed data are synthesized by the logic circuit 115 as described above. Here, the above-described method B is used. That is, the second decompressed data is used for the pixels specified as transparent in the first decompressed data, and the first decompressed data is used for the pixels which are not specified as transparent. As a result, the background map of the central part of Paris and characters describing the “Triumphal Arch of the Star” can be completely restored. On the other hand, part of the photograph of the “Triumphal Arch of the Star” may be lost during the compression and decompression processes.

### EMBODIMENT 8

Embodiment 7 shows a method in which a signal is applied to specify a pixel as transparent; however, the color of the pixel specified as transparent may be set to a color meaning transparency.

For example, the specific color may be set to a color meaning transparency. The color of a pixel specified as transparent is set to a color meaning transparency regardless of the original color. For example, in 24-bit full-color, the color meaning transparency is set to (R, G, B)=(115/2⁸, 212/2⁸, 78/2⁸).

In this case, the color meaning transparency cannot be used for a display. Another color which is as close as possible thereto has to be used as a substitute. For example, a pixel which needs to display the above-described color has to display a substitute color such as (R, G, B)=(114/2⁸, 212/2⁸, 78/2⁸), (R, G, B)=(115/2⁸, 212/2⁸, 79/2⁸), or the like; however, in the case of using a myriad of colors, e.g., 24-bit full-color, almost no visual difference is noticeable.

When selecting a specific color for the color meaning transparency, statistic frequency of use, the optical cognitive capability of humans, and the like may be considered.

In another example, a color not used by the first image data may be specified as the color meaning transparency. For example, in the case where the first image data is 24-bit full-color and the red component of each of the pixels is not 115/8⁸, this red component is specified as 115/8⁸ in pixels specified as transparent independent from the original color.

In this case, in the case where different first image data use 115/8⁸ for the red component, setting the red component of 115/8⁸ as the color meaning transparency includes a problem. Therefore, it is preferable that in this first image data, another color be specified as the color meaning transparency. That is, the color meaning transparency may be changed per pixel. Thus, information about the color meaning transparency is added to the first image data and then transferred.

When performing arithmetic operation processing, in the case where the color of the pixel is the same as the color meaning transparency, this pixel does not display that color but is processed to be transparent. In this case, in the arithmetic operation processing, first, it is determined if the color of each pixel in the first image data is the same as the color meaning transparency or not.

In the former example, it is determined if the color of each pixel is (R, G, B)=(115/2⁸, 212/2⁸, 78/2⁸) or not, and in the latter example, it is determined whether the red component of the color of each pixel is 115/8⁸ or not. The concerned pixels are processed to be transparent. Not concerned pixels are processed by the above-described method A or method B.

Since the JPEG format does not support transparency information, a pixel can be specified as transparent or not by such a method. Of course, a format supporting transparency such as a PNG format or a GIF format may also be used.

### EMBODIMENT 9

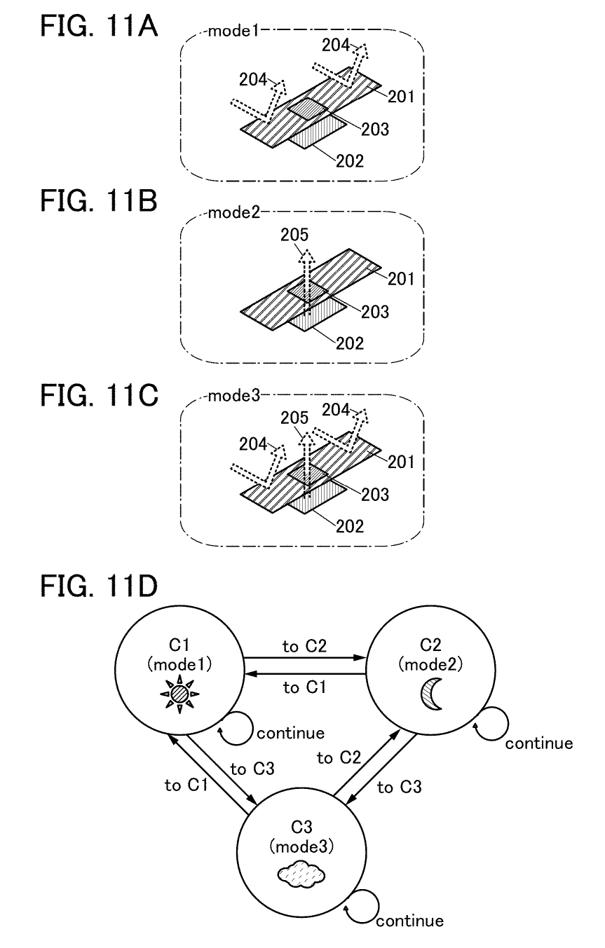

In this embodiment, a display device which can be used as the above-described display unit 109A is described with reference to FIGS. 11A to 11D, FIGS. 12A to 12C, FIG. 13, FIG. 14, FIG. 15, and FIG. 16. The display device of this embodiment includes a first display element reflecting visible light and a second display element emitting visible light.

For example, the display region 117A in the display unit 109A includes first display elements arranged in a matrix, and the display region 117B includes second display elements arranged in a matrix.

The display device of this embodiment has a function of displaying an image using one or both of light reflected by the first display element and light emitted from the second display element.

As the first display element, an element which displays an image by reflecting external light can be used. Such an element does not include a light source and thus power consumption in display can be significantly reduced.

As the first display element, a reflective liquid crystal element can be typically used. As the first display element, other than a Micro Electro Mechanical Systems (MEMS) shutter element or an optical interference type MEMS element, an element using a microcapsule method, an electrophoretic method, an electrowetting method, or the like can also be used.

As the second display element, a light-emitting element is preferably used. Since the luminance and the chromaticity of light emitted from such a display element are hardly affected by external light, a clear image that has high color reproducibility (wide color gamut) and a high contrast can be displayed.

As the second display element, a self-luminous light-emitting element such as an organic light-emitting diode (OLED), a light-emitting diode (LED), a quantum-dot light-emitting diode (QLED), and a semiconductor laser can be used. Note that it is preferable to use, without limitation thereto, a self-luminous light-emitting element as the second display element; however, a transmissive liquid crystal element combining a light source, such as a backlight or a sidelight, and a liquid crystal element can be used, for example.

The display device of this embodiment has a first mode in which an image is displayed using the first display element, a second mode in which an image is displayed using the second display element, and a third mode in which an image is displayed using both the first display element and the second display element. The display device of this embodiment can be switched between the first mode, the second mode, and the third mode automatically or manually. Details of the first to third modes will be described below.

### First Mode

In the first mode, an image is displayed using the first display element and external light. Since a light source is unnecessary in the first mode, power consumed in this mode is extremely low. When sufficient external light enters the display device (e.g., in a bright environment), for example, an image can be displayed by using light reflected by the first display element. The first mode is effective in the case where external light is white light or light near white light and is sufficiently strong, for example. The first mode is suitable for displaying text. Furthermore, the first mode enables eye-friendly display owing to the use of reflected external light, which leads to an effect of easing eyestrain. Note that the first mode may be referred to as reflective display mode (reflection mode) because display is performed using reflected light.

### Second Mode

In the second mode, an image is displayed utilizing light emitted from the second display element. Thus, an extremely vivid image (with high contrast and excellent color reproducibility) can be displayed regardless of the illuminance and the chromaticity of external light. The second mode is effective in the case of extremely low illuminance, such as in a night environment or in a dark room, for example. When a bright image is displayed in a dark environment, a user may feel that the image is too bright. To prevent this, an image with reduced luminance is preferably displayed in the second mode. Thus, not only a reduction in the luminance but also low power consumption can be achieved. The second mode is suitable for displaying a vivid (still and moving) image or the like. Note that the second mode may be referred to as emission display mode (emission mode) because display is performed using light emission, that is, emitted light.

### Third Mode

In the third mode, display is performed utilizing both light reflected by the first display element and light emitted from the second display element. Note that display in which the first display element and the second display element are combined can be performed by driving the first display element and the second display element independently from each other during the same period. Note that in this specification and the like, display in which the first display element and the second display element are combined, i.e., the third mode, can be referred to as a hybrid display mode (HB display mode). Alternatively, the third mode may be referred to as a display mode in which an emission display mode and a reflective display mode are combined (ER-Hybrid mode).

By performing display in the third mode, a clearer image than in the first mode can be displayed and power consumption can be lower than in the second mode. For example, the third mode is effective when the illuminance is relatively low such as under indoor illumination or in the morning or evening hours, or when the external light does not represent a white chromaticity. With the use of the combination of reflected light and emitted light, an image that makes a viewer feel like looking at a painting can be displayed.

[Specific Example of First to Third Modes]

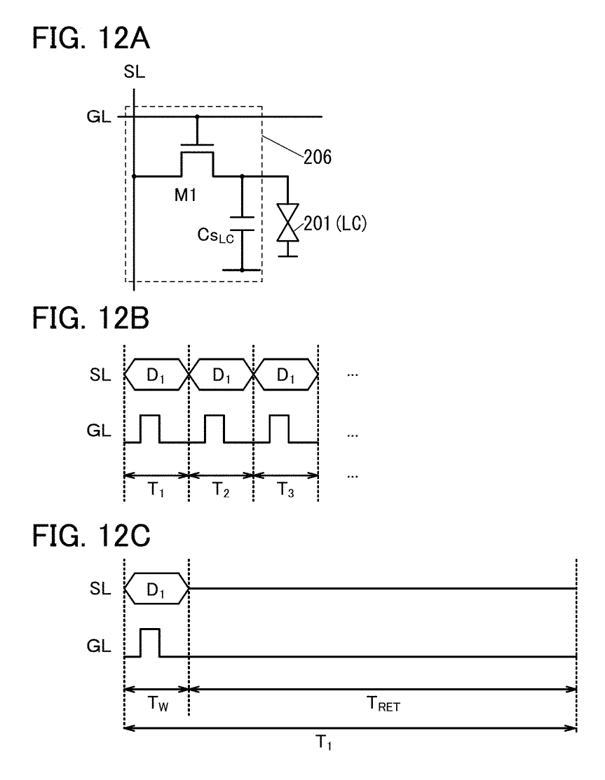

Here, a specific example of the case where the above-described first to third modes are employed is described with reference to FIGS. 11A to 11D and FIGS. 12A to 12C.

Note that the case where the first to third modes are switched automatically depending on the illuminance is described below. In the case where the modes are switched automatically depending on the illuminance, an illuminance sensor or the like is provided in the display device and the display mode can be switched in response to data from the illuminance sensor, for example.

FIGS. 11A to 11C are schematic diagrams of a pixel for describing display modes that are possible for the display device in this embodiment.

In FIGS. 11A to 11C, a first display element 201, a second display element 202, an opening portion 203, reflected light 204 that is reflected by the first display element 201, and transmitted light 205 emitted from the second display element 202 through the opening portion 203 are illustrated. Note that FIG. 11A, FIG. 11B, and FIG. 11C are diagrams illustrating a first mode (mode 1), a second mode (mode 2), and a third mode (mode 3), respectively.

FIGS. 11A to 11C illustrate the case where a reflective liquid crystal element is used as the first display element 201 and a self-luminous OLED is used as the second display element 202.

In the first mode illustrated in FIG. 11A, grayscale display can be performed by driving the reflective liquid crystal element that is the first display element 201 to adjust the intensity of reflected light. For example, as illustrated in FIG. 11A, the intensity of the reflected light 204 reflected by the reflective electrode in the reflective liquid crystal element that is the first display element 201 is adjusted with the liquid crystal layer. In this manner, grayscale can be performed.

In the second mode illustrated in FIG. 11B, grayscale can be expressed by adjusting the emission intensity of the self-luminous OLED that is the second display element 202. Note that light emitted from the second display element 202 passes through the opening portion 203 and is extracted to the outside as the transmitted light 205.

The third mode illustrated in FIG. 11C is a display mode in which the first mode and the second mode which are described above are combined. For example, as illustrated in FIG. 11C, grayscale is expressed in such a manner that the intensity of the reflected light 204 reflected by the reflective electrode in the reflective liquid crystal element that is the first display element 201 is adjusted with the liquid crystal layer. In a period during which the first display element 201 is driven, grayscale is expressed by adjusting the emission intensity of the self-luminous OLED that is the second display element 202, i.e., the intensity of the transmitted light 205.

[State Transition of First to Third Modes]

Next, a state transition of the first to third modes is described with reference to FIG. 11D. FIG. 11D is a state transition diagram of the first mode, the second mode, and the third mode. In FIG. 11D, a state C1, a state C2, and a state C3 correspond to the first mode, the second mode, and the third mode, respectively.

As shown in FIG. 11D, any of the display modes can be selected with illuminance in the states C1 to C3. For example, under a high illuminance such as in outdoor environments, the state can be brought into the state C1. In the case where the illuminance decreases as from outdoors to indoors, the state C1 transitions to the state C2. In the case where the illuminance is low even outdoors and grayscale display with reflected light is not sufficient, the state C2 transitions to the state C3. Needless to say, transition from the state C3 to the state C1, transition from the state C1 to the state C3, transition from the state C3 to the state C2, or transition from the state C2 to the state C1 also occurs.

In FIG. 11D, symbols of the sun, the moon, and a cloud are illustrated as images representing the first mode, the second mode, and the third mode, respectively.

As illustrated in FIG. 11D, in the case where the illuminance does not change or slightly changes in the states C1 to C3, the present state may be maintained without transitioning to another state.

The above structure of switching the display mode in accordance with illuminance contributes to a reduction in the frequency of grayscale display with the intensity of light emitted from the light-emitting element, which requires a relatively high power consumption. Accordingly, the power consumption of the display device can be reduced. In the display device, the operation mode can be further switched in accordance with the amount of remaining battery power, the contents to be displayed, or the illuminance of the surrounding environment. Although the case where the display mode is automatically switched with illuminance is described above as an example, one embodiment of the present invention is not limited thereto, and a user may switch the display mode manually.

<Operation Mode>

Next, an operation mode which can be employed in the first display element is described with reference to FIGS. 12A to 12C.

A normal driving mode (Normal mode) with a normal frame frequency (typically, higher than or equal to 60 Hz and lower than or equal to 240 Hz) and an idling stop (IDS) driving mode with a low frame frequency will be described below.

Note that the idling stop (IDS) driving mode refers to a driving method in which after image data is written, rewriting of image data is stopped. This increases the interval between writing of image data and subsequent writing of image data, thereby reducing the power that would be consumed by writing of image data in that interval. The idling stop (IDS) driving mode can be performed at a frame frequency which is 1/100 to 1/10 of the normal driving mode, for example.

FIGS. 12A to 12C are a circuit diagram and timing charts illustrating the normal driving mode and the idling stop (IDS) driving mode. Note that in FIG. 12A, the first display element 201 (here, a liquid crystal element) and a pixel circuit 206 electrically connected to the first display element 201 are illustrated. In the pixel circuit 206 illustrated in FIG. 12A, a signal line SL, a gate line GL, a transistor M1 connected to the signal line SL and the gate line GL, and a capacitor C_{SLC} connected to the transistor M1 are illustrated.

A transistor including a metal oxide in a semiconductor layer is preferably used as the transistor M1. A metal oxide having at least one of an amplification function, a rectification function, and a switching function can be referred to as a metal oxide semiconductor or an oxide semiconductor (abbreviated to an OS). As a typical example of a transistor, a transistor including an oxide semiconductor (OS transistor) is described. The OS transistor has an extremely low leakage current in a non-conduction state (off-state current), so that charge can be retained in a pixel electrode of a liquid crystal element when the OS transistor is turned off

FIG. 12B is a timing chart showing waveforms of signals supplied to the signal line SL and the gate line GL in the normal driving mode. In the normal driving mode, a normal frame frequency (e.g., 60 Hz) is used for operation. In the case where one frame period is divided into periods T₁ to T₃, a scanning signal is supplied to the gate line GL in each frame period and data D₁ is written from the signal line SL. This operation is performed both to write the same data D₁ in the periods T₁ to T₃ and to write different data in the periods T₁ to T₃.

FIG. 12C is a timing chart showing waveforms of signals supplied to the signal line SL and the gate line GL in the idling stop (IDS) driving mode. In the idling stop (IDS) driving, a low frame frequency (e.g., 1 Hz) is used for operation. One frame period is denoted by a period T₁ and includes a data writing period T_{W} and a data retention period T_{RET}. In the idling stop (IDS) driving mode, a scanning signal is supplied to the gate line GL and the data D₁ of the signal line SL is written in the period T_{W}, the gate line GL is fixed to a low-level voltage in the period T_{RET}, and the transistor M1 is turned off so that the written data D₁ is retained.

The idling stop (IDS) driving mode is effective in combination with the aforementioned first mode or third mode, in which case power consumption can be further reduced.

As described above, the display device of this embodiment can display an image by switching between the first to third modes. Thus, an all-weather display device or a highly convenient display device with high visibility regardless of the ambient brightness can be fabricated.

The display device of this embodiment preferably includes a plurality of first pixels including first display elements and a plurality of second pixels including second display elements. The first pixels and the second pixels are preferably arranged in matrices.

Each of the first pixels and the second pixels can include one or more sub-pixels. The pixel can include, for example, one sub-pixel (e.g., a white (W) sub-pixel), three sub-pixels (e.g., red (R), green (G), and blue (B) sub-pixels), or four sub-pixels (e.g., red (R), green (G), blue (B), and white (W) sub-pixels, or red (R), green (G), blue (B), and yellow (Y) sub-pixels). Note that color elements included in the first and second pixels are not limited to the above, and may be combined with another color such as cyan (C), magenta (M), or the like as necessary.

The display device of this embodiment can be configured to display a full color image using either the first pixels or the second pixels. Alternatively, the display device of this embodiment can be configured to display a black-and-white image or a grayscale image using the first pixels and can display a full-color image using the second pixels. The first pixels that can be used for displaying a black-and-white image or a grayscale image are suitable for displaying information that need not be displayed in color such as text information.

<Schematic Perspective View of Display Device>

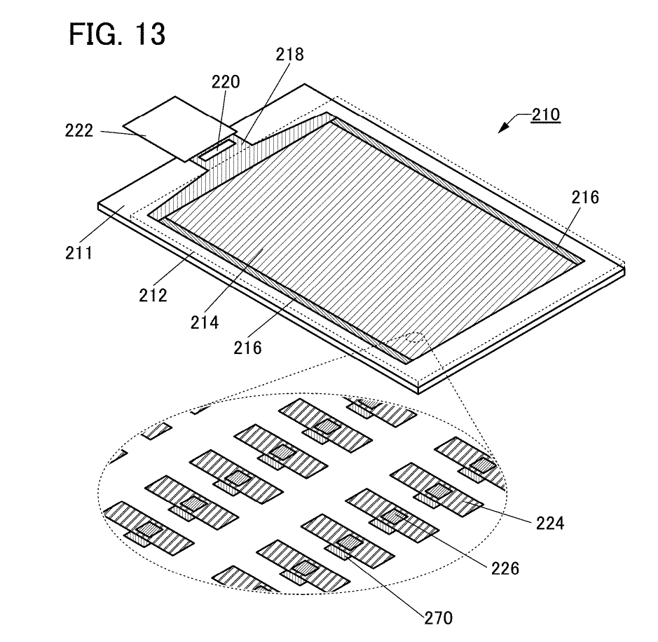

Next, a display device of this embodiment is described with reference to FIG. 13. FIG. 13 is a schematic perspective view of a display device 210.

In the display device 210, a substrate 211 and a substrate 212 are attached to each other. In FIG. 13, the substrate 212 is denoted by a dashed line.

The display device 210 includes a display portion 214, a circuit 216, a wiring 218, and the like. FIG. 13 illustrates an example in which the display device 210 is provided with an IC 220 and an FPC 222. Thus, the structure illustrated in FIG. 13 can be regarded as a display module including the display device 210, the IC 220, and the FPC 222.

As the circuit 216, for example, a scan line driver circuit can be used.

The wiring 218 has a function of supplying a signal and power to the display portion 214 and the circuit 216. The signal and the power is input to the wiring 218 from the outside through the FPC 222 or from the IC 220.

FIG. 13 illustrates an example in which the IC 220 is provided over the substrate 211 by a chip on glass (COG) method, a chip on film (COF) method, or the like. An IC including a scan line driver circuit, a signal line driver circuit, or the like can be used as the IC 220, for example. Note that the display device 210 is not necessarily provided with the IC 220. The IC 220 may be mounted on the FPC by a COF method or the like.

FIG. 13 also shows an enlarged view of part of the display portion 214. Electrodes 224 included in a plurality of display elements are arranged in a matrix in the display portion 214. The electrodes 224 have a function of reflecting visible light, and serve as reflective electrodes of a liquid crystal element 250 (described later).

Furthermore, as illustrated in FIG. 13, the electrode 224 includes an opening portion 226. Additionally, the display portion 214 includes a light-emitting element 270 that is positioned closer to the substrate 211 than the electrode 224 is. Light from the light-emitting element 270 is emitted to the substrate 212 side through the opening portion 226 in the electrode 224. The area of a light-emitting region in the light-emitting element 270 may be equal to that of the opening portion 226. One of the area of the light-emitting region in the light-emitting element 270 and the area of the opening portion 226 is preferably larger than the other because a margin for misalignment can be increased.

<Structural Example 1>

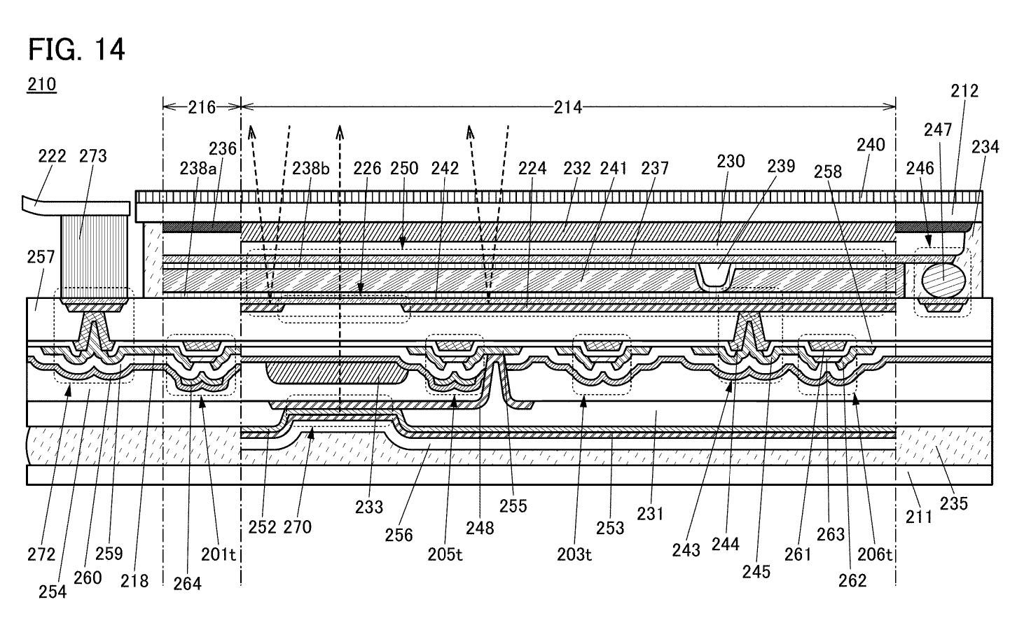

FIG. 14 illustrates an example of cross-sections of part of a region including the FPC 222, part of a region including the circuit 216, and part of a region including the display portion 214 of the display device 210 illustrated in FIG. 13.

The display device 210 illustrated in FIG. 14 includes, between the substrate 211 and the substrate 212, a transistor 201t, a transistor 203t, a transistor 205t, a transistor 206t, the liquid crystal element 250, the light-emitting element 270, an insulating layer 230, an insulating layer 231, a coloring layer 232, a coloring layer 233, and the like. The substrate 212 is bonded to the insulating layer 230 with a bonding layer 234. The substrate 211 is bonded to the insulating layer 231 with a bonding layer 235.

The substrate 212 is provided with the coloring layer 232, a light-blocking layer 236, the insulating layer 230, an electrode 237 functioning as a common electrode of the liquid crystal element 250, an alignment film 238b, an insulating layer 239, and the like. A polarizing plate 240 is provided on an outer surface of the substrate 212. The insulating layer 230 may have a function as a planarization layer. The insulating layer 230 enables the electrode 237 to have an almost flat surface, resulting in a uniform alignment state of a liquid crystal layer 241. The insulating layer 239 serves as a spacer for holding a cell gap of the liquid crystal element 250. In the case where the insulating layer 239 transmits visible light, the insulating layer 239 may be positioned to overlap with a display region of the liquid crystal element 250.

The liquid crystal element 250 is a reflective liquid crystal element. The liquid crystal element 250 has a stacked-layer structure of an electrode 242 functioning as a pixel electrode, the liquid crystal layer 241, and the electrode 237. The electrode 224 that reflects visible light is provided in contact with a surface of the electrode 242 on the substrate 211 side. The electrode 224 includes the opening portion 226. The electrode 242 and the electrode 237 transmit visible light. An alignment film 238a is provided between the liquid crystal layer 241 and the electrode 242. The alignment film 238b is provided between the liquid crystal layer 241 and the electrode 237.

In the liquid crystal element 250, the electrode 224 has a function of reflecting visible light, and the electrode 237 has a function of transmitting visible light. Light entering from the substrate 212 side is polarized by the polarizing plate 240, transmitted through the electrode 237 and the liquid crystal layer 241, and reflected by the electrode 224. Then, the light is transmitted through the liquid crystal layer 241 and the electrode 237 again to reach the polarizing plate 240. In this case, alignment of a liquid crystal can be controlled with a voltage that is applied between the electrode 224 and the electrode 237, and thus optical modulation of light can be controlled. In other words, the intensity of light emitted through the polarizing plate 240 can be controlled. Light excluding light in a particular wavelength region is absorbed by the coloring layer 232, and thus, emitted light is red light, for example.

As illustrated in FIG. 14, the electrode 242 that transmits visible light is preferably provided in the opening portion 226. Accordingly, the liquid crystal layer 241 is aligned in a region overlapping with the opening portion 226 as well as in the other regions, in which case defective alignment of the liquid crystal is prevented from being caused in the boundary portion of these regions and undesired light leakage can be suppressed.

At a connection portion 243, the electrode 224 is electrically connected to a conductive layer 245 included in the transistor 206t via a conductive layer 244. The transistor 206t has a function of controlling the driving of the liquid crystal element 250.

A connection portion 246 is provided in part of a region where the bonding layer 234 is provided. In the connection portion 246, a conductive layer obtained by processing the same conductive film as the electrode 242 is electrically connected to part of the electrode 237 with a connector 247. Accordingly, a signal or a potential input from the FPC 222 connected to the substrate 211 side can be supplied to the electrode 237 formed on the substrate 212 side through the connection portion 246.

As the connector 247, a conductive particle can be used, for example. As the conductive particle, a particle of an organic resin, silica, or the like coated with a metal material can be used. It is preferable to use nickel or gold as the metal material because contact resistance can be decreased. It is also preferable to use a particle coated with layers of two or more kinds of metal materials, such as a particle coated with nickel and further with gold. A material capable of elastic deformation or plastic deformation is preferably used for the connector 247. As illustrated in FIG. 14, the connector 247 which is the conductive particle has a shape that is vertically crushed in some cases. With the crushed shape, the contact area between the connector 247 and a conductive layer electrically connected to the connector 247 can be increased, thereby reducing contact resistance and suppressing the generation of problems such as disconnection.

The connector 247 is preferably provided so as to be covered with the bonding layer 234. For example, the connector 247 is dispersed in the bonding layer 234 before curing of the bonding layer 234.

The light-emitting element 270 is a bottom-emission light-emitting element. The light-emitting element 270 has a stacked-layer structure in which an electrode 248 serving as a pixel electrode, an EL layer 252, and an electrode 253 serving as a common electrode are stacked in this order from the insulating layer 230 side. The electrode 248 is connected to a conductive layer 255 included in the transistor 205t through an opening provided in an insulating layer 254. The transistor 205t has a function of controlling the driving of the light-emitting element 270. The insulating layer 231 covers an end portion of the electrode 248. The electrode 253 includes a material that reflects visible light, and the electrode 248 includes a material that transmits visible light. An insulating layer 256 is provided to cover the electrode 253. Light is emitted from the light-emitting element 270 to the substrate 212 side through the coloring layer 233, the insulating layer 230, the opening portion 226, and the like.

The liquid crystal element 250 and the light-emitting element 270 can exhibit various colors when the color of the coloring layer varies among pixels. The display device 210 can perform color display using the liquid crystal element 250. The display device 210 can perform color display using the light-emitting element 270.

The transistor 201t, the transistor 203t, the transistor 205t, and the transistor 206t are formed on a plane of an insulating layer 257 on the substrate 211 side. These transistors can be fabricated using the same process.

A circuit electrically connected to the liquid crystal element 250 and a circuit electrically connected to the light-emitting element 270 are preferably formed on the same plane. In that case, the thickness of the display device can be smaller than that in the case where the two circuits are formed on different planes. Furthermore, since two transistors can be formed in the same process, a manufacturing process can be simplified as compared to the case where two transistors are formed on different planes.

The pixel electrode of the liquid crystal element 250 is positioned on the opposite side of a gate insulating layer included in the transistor from the pixel electrode of the light-emitting element 270.

The transistor 203t is a transistor for controlling whether the pixel is selected or not (such a transistor is also referred to as a switching transistor or a selection transistor). The transistor 205t is a transistor (also referred to as a driving transistor) for controlling current flowing to the light-emitting element 270. Note that as a material used for a channel formation region in the transistor, a metal oxide is preferably used.

Insulating layers such as an insulating layer 258, an insulating layer 259, an insulating layer 260, and the like are provided on the substrate 211 side of the insulating layer 257. Part of the insulating layer 258 functions as a gate insulating layer of each transistor. The insulating layer 259 is provided to cover the transistor 206t and the like. The insulating layer 260 is provided to cover the transistor 205t and the like. The insulating layer 254 functions as a planarization layer. Note that the number of insulating layers covering the transistor is not limited and may be one or two or more.

A material through which impurities such as water or hydrogen do not easily diffuse is preferably used for at least one of the insulating layers that cover the transistors. This is because such an insulating layer can serve as a barrier film. Such a structure can effectively suppress diffusion of the impurities into the transistors from the outside, and a highly reliable display device can be achieved.

The transistors 201t, 203t, 205t, and 206t include a conductive layer 261 functioning as a gate, the insulating layer 258 functioning as a gate insulating layer, the conductive layer 245 and a conductive layer 262 functioning as a source and a drain, and a semiconductor layer 263. Here, a plurality of layers obtained by processing the same conductive film are shown with the same hatching pattern.

The transistors 201t and 205t each include a conductive layer 264 functioning as a gate in addition to the components of the transistor 203t or 206t.

The structure in which the semiconductor layer where a channel is formed is provided between two gates is used as an example of the transistors 201t and 205t. Such a structure enables the control of the threshold voltage of a transistor. In that case, the two gates may be connected to each other and supplied with the same signal to operate the transistor. Such transistors can have a higher field-effect mobility and thus have higher on-state current than other transistors. Consequently, a circuit capable of high-speed operation can be obtained. Furthermore, the area occupied by a circuit portion can be reduced. The use of the transistor having high on-state current can reduce signal delay in wirings and can reduce display unevenness even in a display device in which the number of wirings is increased because of increase in size or definition.

Alternatively, by supplying a potential for controlling the threshold voltage to one of the two gates and a potential for driving to the other, the threshold voltage of the transistors can be controlled.

Note that the structure of the transistors included in the display device is not limited. The transistor included in the circuit 216 and the transistor included in the display portion 214 may have the same structure or different structures. A plurality of transistors included in the circuit 216 may have the same structure or a combination of two or more kinds of structures. Similarly, a plurality of transistors included in the display portion 214 may have the same structure or a combination of two or more kinds of structures.

A connection portion 272 is provided in a region where the substrates 211 and 212 do not overlap with each other. In the connection portion 272, the wiring 218 is electrically connected to the FPC 222 via a connection layer 273. The connection portion 272 has a similar structure to the connection portion 243. On the top surface of the connection portion 272, a conductive layer obtained by processing the same conductive film as the electrode 242 is exposed. Thus, the connection portion 272 and the FPC 222 can be electrically connected to each other through the connection layer 273.

As the polarizing plate 240 provided on the outer surface of the substrate 212, a linear polarizing plate or a circularly polarizing plate can be used. An example of a circularly polarizing plate is a stack including a linear polarizing plate and a quarter-wave retardation plate. Such a structure can reduce reflection of external light. The cell gap, alignment, drive voltage, and the like of the liquid crystal element used as the liquid crystal element 250 are controlled depending on the kind of the polarizing plate so that desirable contrast is obtained.

Note that a variety of optical members can be arranged on the outer surface of the substrate 212. Examples of the optical members include a polarizing plate, a retardation plate, a light diffusion layer (e.g., a diffusion film), an anti-reflective layer, and a light-condensing film. Furthermore, an antistatic film preventing the attachment of dust, a water repellent film suppressing the attachment of stain, a hard coat film suppressing generation of a scratch caused by the use, or the like may be arranged on the outer surface of the substrate 212.

For each of the substrates 211 and 212, glass, quartz, ceramic, sapphire, an organic resin, or the like can be used. When the substrates 211 and 212 are formed using a flexible material, the flexibility of the display device can be increased.

A liquid crystal element having, for example, a vertical alignment (VA) mode can be used as the liquid crystal element 250. Examples of the vertical alignment mode include a multi-domain vertical alignment (MVA) mode, a patterned vertical alignment (PVA) mode, and an advanced super view (ASV) mode.

Liquid crystal elements using a variety of modes can be used as the liquid crystal element 250. For example, a liquid crystal element using, instead of a vertical alignment (VA) mode, a twisted nematic (TN) mode, an in-plane switching (IPS) mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, or the like can be used.

The liquid crystal element controls the transmission or non-transmission of light utilizing an optical modulation action of a liquid crystal. The optical modulation action of the liquid crystal is controlled by an electric field (including a horizontal electric field, a vertical electric field, and an oblique electric field) applied to the liquid crystal. As the liquid crystal used for the liquid crystal element, a thermotropic liquid crystal, a low-molecular liquid crystal, a high-molecular liquid crystal, a polymer dispersed liquid crystal (PDLC), a ferroelectric liquid crystal, an anti-ferroelectric liquid crystal, or the like can be used. Such a liquid crystal material exhibits a cholesteric phase, a smectic phase, a cubic phase, a chiral nematic phase, an isotropic phase, or the like depending on conditions.

As the liquid crystal material, either of a positive liquid crystal and a negative liquid crystal may be used, and an appropriate liquid crystal material can be used depending on the mode or design to be used.

In addition, to control the alignment of the liquid crystal, an alignment film can be provided. In the case where a horizontal electric field mode is employed, a liquid crystal exhibiting a blue phase for which an alignment film is unnecessary may be used. A blue phase is one of liquid crystal phases, which is generated just before a cholesteric phase changes into an isotropic phase while temperature of cholesteric liquid crystal is increased. Since the blue phase appears only in a narrow temperature range, a liquid crystal composition in which several weight percent or more of a chiral material is mixed is used for the liquid crystal in order to improve the temperature range. The liquid crystal composition which includes liquid crystal exhibiting a blue phase and a chiral material has a short response time and optical isotropy, which makes the alignment process unneeded. In addition, the liquid crystal composition which includes liquid crystal exhibiting a blue phase and a chiral material has a small viewing angle dependence. An alignment film does not need to be provided and rubbing treatment is thus not necessary; accordingly, electrostatic discharge damage caused by the rubbing treatment can be prevented and defects and damage of the liquid crystal display device in the manufacturing process can be reduced.

In the case where a reflective liquid crystal element is used, the polarizing plate 240 is provided on the display surface side. In addition, a light diffusion plate is preferably provided on the display surface to improve visibility.

A front light may be provided on the outer side of the polarizing plate 240. As the front light, an edge-light front light is preferably used. A front light including a light-emitting diode (LED) is preferably used to reduce power consumption.

<Structural Example 2>

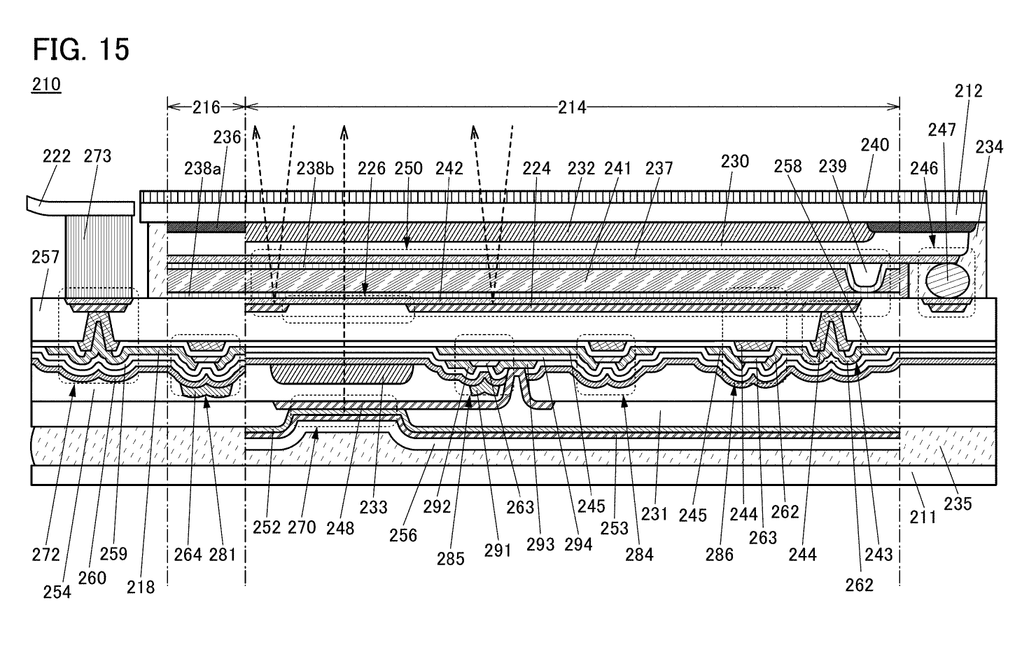

Next, a different mode of the display device 210 shown in FIG. 14 will be described with reference to FIG. 15.

The display device 210 illustrated in FIG. 15 includes a transistor 281, a transistor 284, a transistor 285, and a transistor 286 instead of the transistor 201t, the transistor 203t, the transistor 205t, and the transistor 206t. Components other than the transistors have basically the same structures as those in the display device 210 shown in FIG. 14. However, part of the components have different structures; thus, description of portions which are similar is omitted, while different structures will be described below.

The positions of the insulating layer 239, the connection portion 243, and the like in FIG. 15 are different from those in FIG. 14. The insulating layer 239 is provided so as to overlap with an end portion of the coloring layer 232. Furthermore, the insulating layer 239 is provided so as to overlap with an end portion of the light-blocking layer 236. As in this structure, the insulating layer 239 may be provided in a region not overlapping with a display region (or in a region overlapping with the light-blocking layer 236).

A plurality transistors included in the display device may partly overlap with each other like the transistor 284 and the transistor 285. In that case, the area occupied by a pixel circuit can be reduced, leading to an increase in resolution. Furthermore, the light-emitting area of the light-emitting element 270 can be increased, leading to an improvement in aperture ratio. The light-emitting element 270 with a high aperture ratio requires low current density to obtain necessary luminance; thus, the reliability is improved.

Each of the transistors 281, 284, and 286 includes the conductive layer 244, the insulating layer 258, the semiconductor layer 263, the conductive layer 245, and the conductive layer 262. The conductive layer 244 overlaps with the semiconductor layer 263 with the insulating layer 258 positioned therebetween. The conductive layer 262 is electrically connected to the semiconductor layer 263. The transistor 281 includes the conductive layer 264.

The transistor 285 includes the conductive layer 245, the insulating layer 259, the semiconductor layer 263, a conductive layer 291, the insulating layer 259, the insulating layer 260, a conductive layer 292, and a conductive layer 293. The conductive layer 291 overlaps with the semiconductor layer 263 with an insulating layer 290 and the insulating layer 260 positioned therebetween. The conductive layer 292 and the conductive layer 293 are electrically connected to the semiconductor layer 263.

The conductive layer 245 functions as a gate. An insulating layer 294 functions as a gate insulating layer. The conductive layer 292 functions as one of a source and a drain. The conductive layer 245 included in the transistor 286 functions as the other of the source and the drain.

<Structural Example 3>

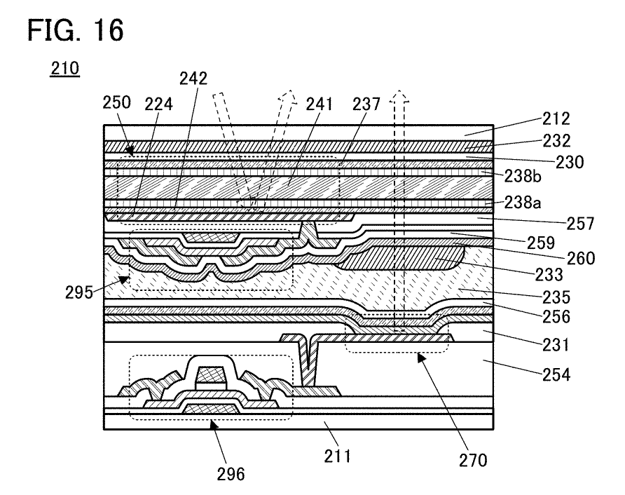

Next, a different mode of the display device 210 shown in FIG. 14 and FIG. 15 will be described with reference to FIG. 16. FIG. 16 is a cross-sectional view of a display portion of the display device 210.

The display device 210 illustrated in FIG. 16 includes, between the substrate 211 and the substrate 212, a transistor 295, a transistor 296, the liquid crystal element 250, the light-emitting element 270, the insulating layer 230, the coloring layer 232, the coloring layer 233, and the like.

In the liquid crystal element 250, the electrode 224 reflects external light to the substrate 212 side. The light-emitting element 270 emits light to the substrate 212 side. For the structures of the liquid crystal element 250 and the light-emitting element 270, Structural example 1 can be referred to.

The transistor 295 is covered with the insulating layer 259 and the insulating layer 260. The insulating layer 256 and the coloring layer 233 are bonded to each other with the bonding layer 235.

Furthermore, the transistor 296 has a different structure than the ones in the above-described Structural examples 1 and 2. Specifically, the transistor 296 is a dual-gate transistor. Note that the gate electrode below the transistor 296 may not be provided, and a top gate transistor may be used.

In the display device 210 illustrated in FIG. 16, the transistor 295 for driving the liquid crystal element 250 and the transistor 296 for driving the light-emitting element 270 are formed over different planes; thus, each of the transistors can be easily formed using a structure and a material suitable for driving the corresponding display element.

This application is based on Japanese Patent Applications Serial No. 2016-163236, No. 2016-163237, and No. 2016-163239 filed with Japan Patent Office on Aug. 24, 2016, the entire contents of which are hereby incorporated by reference.

What is claimed is:

1. An electronic device system comprising a processor, a first circuit, a second circuit, and a display unit,
wherein the processor is configured to generate first image data and second image data,
wherein the first circuit is configured to compress the first image data and the second image data under different compression conditions to generate first compressed data and second compressed data,
wherein the second circuit is configured to decompress the first compressed data and the second compressed data to generate first decompressed data and second decompressed data, and
wherein the display unit is configured to use the first decompressed data and the second decompressed data to perform display.

2. The electronic device system according to claim 1, wherein one of the first image data and the second image data includes a pixel specified as black by the processor.

3. The electronic device system according to claim 1,
wherein the first compressed data and the second compressed data are in a JPEG format or in a format similar thereto, and
wherein the first image data is configured to be compressed under a reversible compression condition.

4. The electronic device system according to claim 1, wherein the first circuit is configured to compress the first image data with a first encoder circuit and the second image data with a second encoder circuit.

5. The electronic device system according to claim 1, wherein the second circuit is configured to decompress the first compressed data with a first decoder circuit and the second compressed data with a second decoder circuit.

6. The electronic device system according to claim 1, further comprising:
a first data bus and a second data bus,
wherein the first compressed data and the second compressed data are transferred to the second circuit through the first data bus and the second data bus, respectively.

7. The electronic device system according to claim 1,
wherein the display unit comprises a first display region and a second display region,
wherein the first display region performs display corresponding to the first decompressed data,
wherein the second display region performs display corresponding to the second decompressed data,
wherein the first display region overlaps with the second display region, and
wherein the first display region is configured to transmit light emitted from the second display region.

8. The electronic device system according to claim 7,
wherein the first display region comprises a reflective pixel, and
wherein the second display region comprises a self-luminous pixel.

9. The electronic device system according to claim 1,
wherein the display unit comprises a display region, and
wherein the display region is configured to sequentially perform display corresponding to the first decompressed data and display corresponding to the second decompressed data.

10. The electronic device system according to claim 1, wherein the number of pixels of the first image data is smaller than the number of pixels of the second image data.

11. An electronic device system comprising a processor, a first circuit, a second circuit, and a display unit,
wherein the processor is configured to generate first image data and second image data,
wherein the first circuit is configured to compress the first image data and the second image data with different compression methods to generate first compressed data and second compressed data,
wherein the second circuit is configured to decompress the first compressed data and the second compressed data to generate first decompressed data and second decompressed data, and
wherein the display unit is configured to use the first decompressed data and the second decompressed data to perform display.

12. The electronic device system according to claim 11, wherein the first image data and the second image data are configured to be compressed into a reversible compression format and an irreversible compression format, respectively.

13. The electronic device system according to claim 11, wherein one of the first image data and the second image data includes a pixel specified as black by the processor.

14. The electronic device system according to claim 11,
wherein the first compressed data is in a GIF format, a PNG format, or in a format similar thereto, and
wherein the second compressed data is in a JPEG format or in a format similar thereto.

15. The electronic device system according to claim 11, wherein the first circuit is configured to compress the first image data with a first encoder circuit and the second image data with a second encoder circuit.

16. The electronic device system according to claim 11, wherein the second circuit is configured to decompress the first compressed data with a first decoder circuit and the second compressed data with a second decoder circuit.

17. The electronic device system according to claim 11, further comprising:
a first data bus and a second data bus,
wherein the first compressed data and the second compressed data are transferred to the second circuit through the first data bus and the second data bus, respectively.

18. The electronic device system according to claim 11,
wherein the display unit comprises a first display region and a second display region,
wherein the first display region overlaps with the second display region, and
wherein the first display region is configured to transmit light emitted from the second display region.

19. The electronic device system according to claim 18,
wherein the first display region comprises a reflective pixel, and
wherein the second display region comprises a self-luminous pixel.

20. The electronic device system according to claim 11,
wherein the display unit comprises a display region, and
wherein the display region is configured to sequentially perform display corresponding to the first decompressed data and display corresponding to the second decompressed data.

21. An electronic device system comprising a processor, a first circuit, a second circuit, and a display unit,
wherein the processor is configured to generate first image data including information specifying transparency or non-transparency and second image data,
wherein the first circuit is configured to compress the first image data and the second image data to generate first compressed data and second compressed data,
wherein the second circuit is configured to decompress the first compressed data and the second compressed data to generate first decompressed data and second decompressed data, and
wherein the display unit is configured to use the first decompressed data and the second decompressed data to perform display.

22. The electronic device system according to claim 21,
wherein a pixel specified as transparent in the first decompressed data uses data of a pixel corresponding to the second decompressed data for display, and
wherein a pixel not specified as transparent in the first decompressed data uses data of a pixel of the first decompressed data for display.

23. The electronic device system according to claim 21,
wherein the first compressed data is in a GIF format, a PNG format, or in a format similar thereto, and
wherein the second compressed data is in a JPEG format or in a format similar thereto.

24. The electronic device system according to claim 21, wherein the first circuit is configured to compress the first image data with a first encoder circuit and the second image data with a second encoder circuit.

25. The electronic device system according to claim 21, wherein the second circuit is configured to decompress the first compressed data with a first decoder circuit and the second compressed data with a second decoder circuit.

26. The electronic device system according to claim 21, further comprising:
a first data bus and a second data bus,
wherein the first compressed data and the second compressed data are transferred to the second circuit through the first data bus and the second data bus, respectively.
